(19) United States
(12) Patent Application Publication
(10) Pub. No.: US 2011/0216551 A1
(43) Pub. Date: Sep. 8, 2011

(54) LAMP HOLDING FIXTURE FOR HEADLAMPS

(75) Inventor: Berthold Doring, Werl-Buderich (DE)

(73) Assignee: Hella KGaA, Lippstadt (DE)

(21) Appl. No.: 13/032,795

(22) Filed: Feb. 23, 2011

(30) Foreign Application Priority Data
Mar. 4, 2010 (EP) 10155545.6

(51) Int. Cl. F21V 21/14

(52) U.S. Cl. 362/523

(57) ABSTRACT

The invention relates to a lamp holding fixture for headlamps, particularly for vehicle headlamps, comprising a ring element with a radial holding surface that a base of the lamp rests against and further comprising a tubular holding body made of an electrically conductive material such that said holding body, when the lamp is at its mounting position, extends between an electrically conductive section of a reflector and an electrically conductive housing of a lamp igniter, wherein the tubular holding body is assigned fixing material for holding the lamp in its mounting position and wherein the tubular holding body features a plurality of first contact springs distributed in peripheral direction over a side facing the reflector and a plurality of second contact springs distributed in peripheral direction over another side facing the igniter.

The present invention relates to a lamp holding fixture for headlamps, particularly for vehicle headlamps, comprising a ring element with a radial holding surface that a base of the lamp rests against and further comprising a tubular holding body made of an electrically conductive material such that said holding body, when the lamp is at its mounting position, extends between an electrically conductive section of a reflector and an electrically conductive housing of a lamp igniter, wherein the tubular holding body is assigned fixing material for holding the lamp in its mounting position.

EP 1 801 494 B1 describes a lamp holding fixture for headlamps which comprises a tubular holding body made of an electrically conductive material and extending between a reflector and a lamp igniter. The tubular holding body is assigned fixing material for holding the lamp in its mounting position. The lamp holding fixture also comprises a ring element with a radial holding surface that a base of the lamp rests against. To prevent the emission of an electromagnetic field, a claw is attached to the tubular holding body in axial direction such that the claw contacts an electrically conductive housing of the igniter when the lamp is at its mounting position. This produces and provides an uninterrupted electrically conductive area between the reflector and the igniter. A disadvantage of the lamp holding fixture of the prior art is that, for shielding purposes, electrically conductive claw elements need to be additionally mounted on the tubular holding body.

The task of the present invention is to further develop a lamp holding fixture for headlamps such that a safe and reliable shield against electromagnetic radiation is provided in a simple manner.

To accomplish this task, the invention, in conjunction with the introductory clause of claim 1, is characterized in that the tubular holding body comprises a plurality of first contact springs distributed in peripheral direction over a side facing the reflector and a plurality of second contact springs distributed in peripheral direction over another side facing the igniter.

According to the invention, the front face of the tubular holding body is shaped such that a plurality of first contact springs is distributed in peripheral direction and arranged on or molded to a side facing the reflector and a plurality of second contact springs is distributed in peripheral direction and arranged on or molded to a side facing the igniter. The tubular holding body thus makes direct and safe electrically conductive contact to both the reflector and the igniter. The contact springs preferably contact the reflector and the igniter in a crown-like arrangement in peripheral direction.

In a special embodiment of the invention, the peripheral first contact springs and/or the peripheral second contact springs make an integral whole with a cylindrical section of the tubular holding body. A beneficial aspect is the reduction in costs of production, specifically if the tubular holding body consists of a rolled spring steel sheet. In an advantageous embodiment, the cylindrical section of the holding body can be mounted on an apex section of the reflector to make a detachable connection to said reflector. The resilient first contact springs provide a safe electrical connection of the holding body and at least a certain metal reflector section.

In a further development of the invention, the cylindrical section of the holding body comprises at least one locating element for providing a detachable link between the tubular body and the reflector.

In a further development of the invention, the tubular holding body comprises at least one recess that a retaining spring slots into such that it fixes the lamp at its mounting position in relation to the holding body. The advantage of this feature is in its room-saving fixture because the retaining spring is preferably integrated in the cylindrical section of the holding body.

In a further development of the invention, the ring element is made of a plastic material molded to an apex of the reflector. This is an advantageous and simple way of forming appropriate studs, raised points or similar elements that center the lamp or the igniter in relation to the reflector.

For other advantages of the invention refer to the other dependent claims.

The text below explains an embodiment of the invention with reference to the drawings.

The following is shown:

FIG. 1 a perspective rear view of a lamp holding fixture at its mounting position, wherein the lamp is fixed by a holding spring;

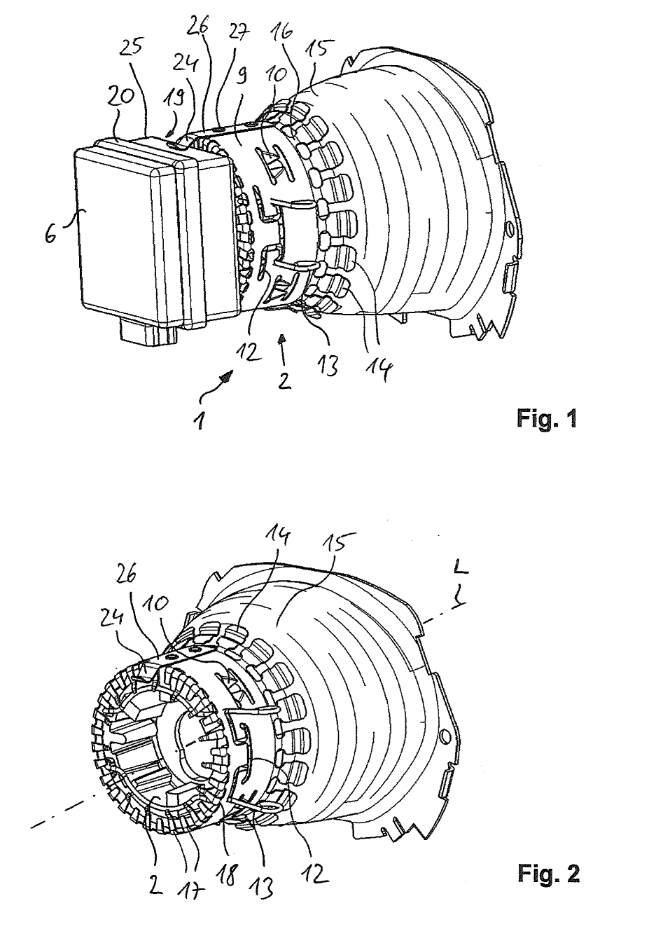

FIG. 2 a perspective rear view of the lamp holding fixture before the lamp and the igniter are mounted on the holding fixture;

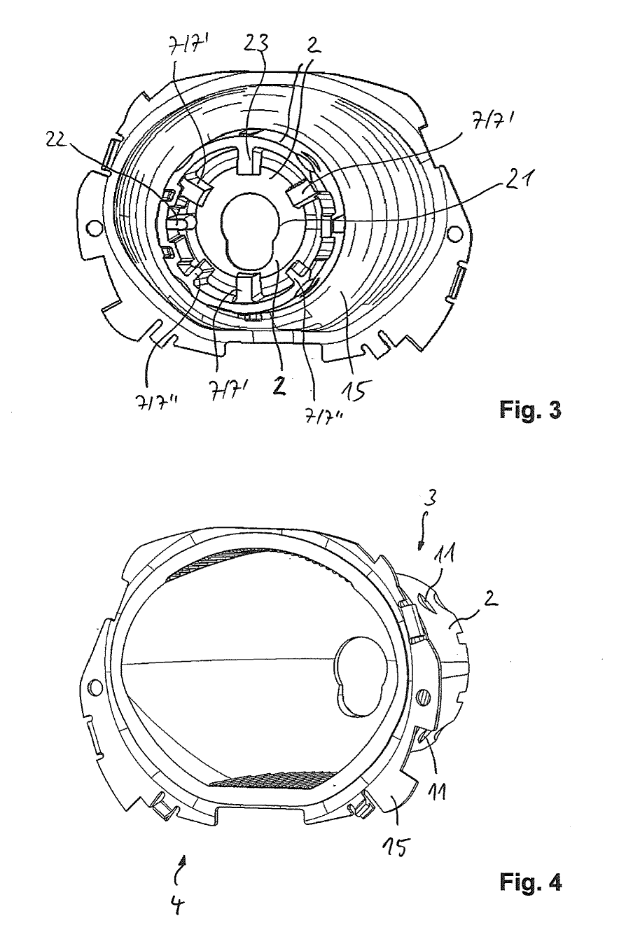

FIG. 3 a rear view of a reflector with a ring element with studs in an annular arrangement molded to its apex;

FIG. 4 a front view of the reflector with a luminous plastic area injection-molded on the inside and the ring element molded to the apex; and

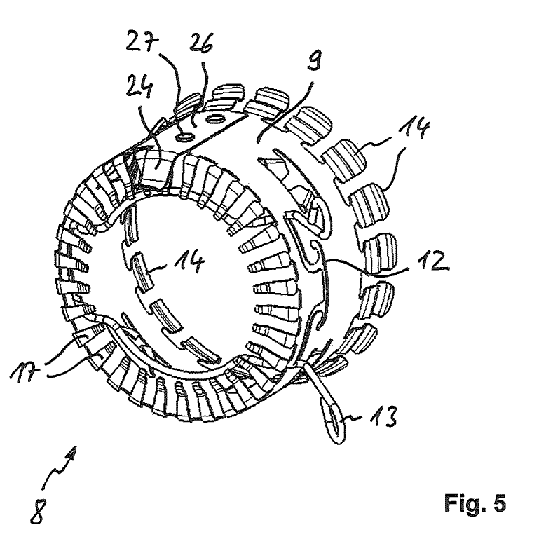

FIG. 5 a perspective view of a tubular holding body of the lamp holding fixture.

A lamp holding fixture 1 according to the invention is preferably used in motor vehicles and, more specifically, in headlamps of motor vehicles. In the present embodiment, the lamp holding fixture 1 comprises a ring element 2 made of a plastic material such that said ring element 2 is molded or injection-molded to an apex 3 of a reflector 4. The ring element 2 comprises a plurality of studs 7 protruding in axial and/or in radial direction such that said studs 7 ensure that the base of a lamp rigidly connected to an igniter 6 or the igniter 6 is placed at the reflector 4 in the correct position when the assembly is at its mounting position.

The lamp holding fixture 1 further comprises a tubular holding body 8 made of an electrically conductive material. The tubular holding body 8 comprises a cylindrical section 9 comprising a plurality of locating elements 10 distributed in peripheral direction such that said locating elements 10 interact with counter-elements 11 arranged on the outside of the ring element 2, the effect being that a detachable connection is made between the holding body 8 and the ring element 2. The locating elements 10 on the cylindrical section 9 preferably snap in behind an edge of the counter-element 11 such that, at its mounting position, the tubular holding body 8 is clamped to the ring element 2 or the reflector 4.

The cylindrical section 9 further comprises slots 12 (narrow recesses) that a retaining spring 13 slots into by way of a fastener that can be optionally set to a locked and an unlocked position for attaching the lamp or the igniter 6 to the tubular holding body 8.

The tubular holding body 8 is made of metal, preferably of a rolled spring steel sheet, and shaped like a pot.

On a side facing the reflector 4, the tubular holding body 8 comprises a plurality of first contact springs 14 distributed in peripheral direction and, following installation, prestressed to contact an electrically conductive outer surface 15 (electrically conductive section) of the reflector 4. Each of said first contact springs 14 is beak-shaped and tilts towards the outer side at an acute angle with reference to a long axis L of the holding body 8. Comparatively narrow fins 16 connect the first contact springs 14 to the cylindrical section 9 such that said first contact springs 14 are resilient in radial direction to almost or entirely completely contact the outer surface 15 of the reflector 4 following installation.

In an alternative embodiment of the invention, the first contact springs 14 may also point mainly in axial direction. This design of the first contact springs 14 may be given preference if contact is to be made to a concentric connecting piece of the reflector 4.

On a side facing the igniter 6, the tubular holding body 9 comprises a plurality of second contact springs 17 distributed in peripheral direction and mainly arranged in radial direction. Each of the second contact springs 17 connects to the cylindrical section 9 via a separate fin 18. The area of contact of the second contact springs 17 is smaller than that of the first contact springs 14. Following installation, the second contact springs 17 prop up against a radial wall 19 of the igniter 6 such that an uninterrupted electrically conductive connection is provided between an electrically conductive housing 20 of the igniter 6 and the electrically conductive outer surface 15 of the reflector 4. This prevents unwanted electromagnetic radiation from escaping to the outside.

The first contact springs 14 and the second contact springs 17 form an integral whole with the cylindrical section 9 of the tubular holding body 8. Each set is arranged in an annular manner around the long axis L of the holding body 8.

The reflector 4 comprises a basic metal body that, along the outside of its apex 3, plastic material is molded on to to make the ring element 2 and that, on its inside, is injection-molded to provide a reflective coating to serve as a luminous plastic area.

The ring element 2 comprises a central socket hole 21 for inserting the lamp. Three first studs 7′ are distributed across a radial basic side and protrude in axial and/or radial direction to provide an axial rest of the igniter 6 on the ring element 2. Two further studs 7″ are arranged at an approx. 90° offset and provided to set the vertical position of the igniter 6 in relation to the lamp holding fixture 1. Said second studs 7″ are prism-shaped and expand in radial direction towards the inside. A fourth stud 22 is provided for encoding, and a fifth stud 23 is provided to serve as anti-twist guard.

The peripheral distribution of the first contact springs 14 preferably matches that of the second contact springs 17.

The plurality of second contact springs 17 is arranged like a crown on the bottom for the tubular holding body 8 to rest on on the radial wall 19 of the igniter 6.

To improve the shielding effect, the slots 12 are preferably fairly narrow.

In order to place the igniter 6 at the correct radial position, an axial spring 24 protrudes from a side of the cylindrical section 9 facing the igniter 6 such that, following installation, said axial spring 24 rests on a top side wall 25 of the igniter 6. The axial spring 24 is preferably connected to a lug 26 which, by means of rimmed rivets 27, connects to the cylindrical section 9 of the tubular holding body 8.

### REFERENCE ITEMS

1 Lamp holding fixture

2 Ring element

3 Apex

4 Reflector

6 Igniter

7 Studs

8 Holding body

9 Cylindrical section

10 Locating element

11 Counter-element

12 Slots

13 Retaining spring

14 First contact spring

15 Outer surface

16 Connecting fin

17 Second contact spring

18 Connecting fin

19 Radial wall

20 Housing

21 Socket hole

22 Fourth stud

23 Fifth stud

24 Axial spring

25 Side wall

26 Lug

27 Rimmed rivet

L Lamp axis

1. Lamp holding fixture for headlamps, particularly for vehicle headlamps, comprising a ring element with a radial holding surface that a base of the lamp rests against and further comprising a tubular holding body made of an electrically conductive material such that said holding body, when the lamp is at its mounting position, extends between an electrically conductive section of a reflector and an electrically conductive housing of a lamp igniter, wherein the tubular holding body is assigned fixing material for holding the lamp in its mounting position, characterized in that the tubular holding body (8) features a plurality of first contact springs (14) distributed in peripheral direction over a side facing the reflector (4) and a plurality of second contact springs (17) distributed in peripheral direction over another side facing the igniter (6).

2. Lamp holding fixture of claim 1, characterized in that the first contact springs (14) and/or the second contact springs (17) form an integral whole with a cylindrical section (9) of the tubular holding body (8).

3. Lamp holding fixture of claim 1 or 2, characterized in that the first contact springs (14) and/or the second contact springs (17) are arranged in a circular manner around a long axis (L) of the tubular holding body (8) such that the first contact springs (14) open out towards the outside either in axial direction or, in an acute angle, in radial direction to hold the tubular holding body (8) on an outer face (15) of the reflector (4) and also such that the second contact springs (17) extend in radial direction to hold the tubular holding body (8) on a radial wall (19) of the igniter (6).

4. Lamp holding fixture of claims 1 to 3, characterized in that the cylindrical section (9) of the tubular holding body (8) comprises at least one locating element (10) for providing a detachable mount of the tubular holding body (8) on the reflector (4) and/or the ring element (2).

5. Lamp holding fixture of claims 1 to 4, characterized in that the tubular holding body (8) comprises at least one recess (12) that a retaining spring (13) slots into such that it fixes the lamp at its mounting position in relation to the tubular holding body (8).

6. Lamp holding fixture of claims 1 to 5, characterized in that the tubular holding body (8) is made of a sheet metal material.

7. Lamp holding fixture of claims 1 to 6, characterized in that the ring element (2) is made of a plastic material and in that the ring element (2) is molded to an apex (3) of the reflector (4).

8. Lamp holding fixture of claims 1 to 7, characterized in that the ring element (2) comprises a plurality of studs (7, 7′, 7″, 22, 23) protruding from said ring element in axial and/or radial direction to make the base of the lamp and/or the igniter (6) face the right way as they contact the reflector (4).

9. Lamp holding fixture of claims 1 to 8, characterized in that an axial spring (24) protrudes from a side of the tubular holding body (8) facing the igniter (6) such that said axial spring (24) at its mounting position contacts a side wall (25) of the igniter (6) to hold said igniter (6) at its correct radial position in relation to the tubular holding body (8).

10. Lamp holding fixture of claims 1 to 9, characterized in that the tubular holding body (8) is shaped like a pot and in that the second contact springs (17) make up a crown at the bottom.
